(19) United States
(12) Patent Application Publication
(10) Pub. No.: US 2026/0093474 A1
(43) Pub. Date: Apr. 2, 2026

(54) SCALED FIRMWARE DEPLOYMENT BASED ON OBSERVABLE HEALTH MARKERS

(71) Applicant: American Megatrends International, LLC, Duluth, GA (US)

(72) Inventors: CHITRAK GUPTA, Johns Creek, GA (US); Zachary Bobroff, Atlanta, GA (US); Varadachari Sudan Ayanam, Suwanee, GA (US)

(21) Appl. No.: 18/904,351

(22) Filed: Oct. 2, 2024

(51) Int. Cl. G06F 8/65; G06F 11/36

(52) U.S. Cl. CPC G06F 8/65; G06F 11/3612

(57) ABSTRACT

A computer system discovers a plurality of nodes within a data center. The computer system clusters the plurality of nodes into groups based on selectable parameters. The computer system deploys firmware to selected nodes or clusters based on a policy manifest. The computer system monitors firmware stability on the selected nodes by collecting device data from each selected node. The computer system analyzes the collected device data to detect one or more errors. The computer system deploys the firmware to a larger cluster of nodes according to the policy manifest when no errors are detected.

### BACKGROUND

### Field

The present disclosure relates generally to computer systems, and more particularly, to techniques of scaled firmware deployment in a data center based on observable health markers.

### BACKGROUND

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v.2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture.

The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a computer system are provided. The computer system discovers a plurality of nodes within a data center. The computer system clusters the plurality of nodes into groups based on selectable parameters. The computer system deploys firmware to selected nodes or clusters based on a policy manifest. The computer system monitors firmware stability on the selected nodes by collecting device data from each selected node. The computer system analyzes the collected device data to detect one or more errors. The computer system deploys the firmware to a larger cluster of nodes according to the policy manifest when no errors are detected.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system including a baseboard management controller and a host computer.

FIG. 2 is a diagram illustrating a data center with heterogeneous servers managed by baseboard management controllers and components of a firmware deployment system.

FIG. 3 shows a YAML file specifying a policy manifest for a compute cluster, outlining the nodes to be updated, their configurations, and the policies governing the deployment.

FIG. 4 is a flowchart of process for scaled firmware deployment based on observable health markers.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

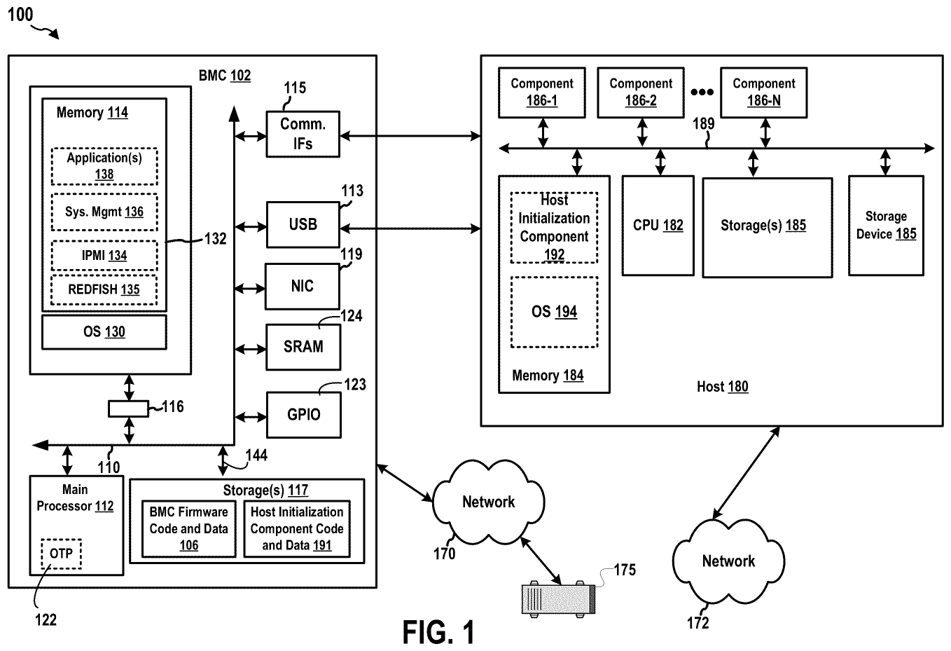

FIG. 1 is a diagram illustrating a computer system 100. In this example, the computer system includes, among other devices, a baseboard management controller (BMC) 102 and a host computer 180. The BMC 102 has, among other components, a main processor 112, a memory 114 (e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123 (i.e., general purpose input/output interface). Further, the main processing unit 112 contains an OTP memory 122 (i.e., one time programmable memory).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 a BMC OS 130 (i.e., operating system) and service components 132. The service components 132 include, among other components, IPMI services 134, Redfish services 135, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January, 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170.

Further, the storage(s) 117 is in communication with the communication channel 110 through a communication link 144.

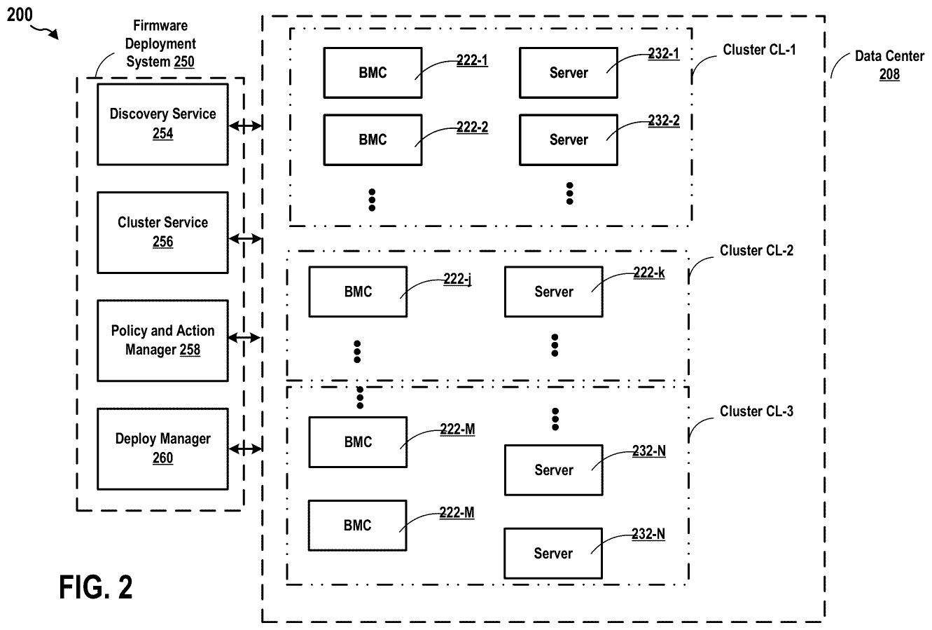

FIG. 2 is a diagram 200 illustrating a data center. In this example, a data center 208 includes heterogeneous servers 232-1, 232-2, . . . , 232-N. These servers represent the diverse array of hardware configurations typically found in modern data centers. To manage these servers, BMCs 222-1, 222-2, . . . , 222-M are employed, each responsible for monitoring and managing one or more servers.

This diverse hardware environment complicates the process of firmware updates, as each server may have unique requirements and potential vulnerabilities. The primary concern for data center administrators is maintaining system health and avoiding downtime during firmware updates. Traditionally, this has led to a conservative approach where updates are only applied when absolutely necessary. This cautious stance, while understandable, creates a bottleneck for companies in delivering frequent updates and new software features. The risk associated with firmware updates is particularly acute in a data center environment, where a single failed update could potentially impact multiple servers or even an entire cluster.

To address these challenges, an intelligent policy-based firmware management solution is proposed. This solution utilizes the capabilities of the BMC 102, as detailed in FIG. 1, to create a more structured and comfortable approach to firmware deployment. The BMC 102 may serve as the central point for implementing this new firmware management strategy. This solution may enable IT administrators to confidently keep their systems updated without the fear of downtime, by providing the structured and scalable approach to firmware deployment that minimizes risk and ensures system health. In particular, the BMCs, such as the BMC 102, can implement a policy-driven, incremental deployment of firmware updates across the servers in a data center.

Initially, upon the release of a new firmware version, the firmware is deployed to a selected subset of nodes within the data center 208. These nodes may be among the heterogeneous servers 232-1, 232-2, . . . , 232-N, each managed by a corresponding one of the BMCs 222-1, 222-2, . . . , 222-M. The selection of nodes for the initial deployment is based on an administrator-defined policy manifest, which can include criteria such as workload type, CPU or GPU specifications, server generation, existing firmware versions, and other relevant parameters.

The policy manifest is a detailed document, for example formatted in YAML or JSON, that specifies the parameters controlling the firmware update process. For example, the policy may define the initial number of nodes to be updated, the scaling increments for subsequent deployment phases, error management strategies, and actions to be taken in response to detected issues.

The deployed firmware includes integrated telemetry and analytics packages that collect data from the firmware entity, including system logs, health information, and event notifications. This data is transmitted to a firmware deployment system 250 in the cloud or on premises via network interfaces such as the network interface card 119 in the BMC 102.

The firmware deployment system 250 continuously monitors the collected data from the updated nodes over a specified observation period. It analyzes the data for predefined markers or indicators of issues, such as system error logs (SEL), process logs from the BMC, or other health metrics. If the service detects anomalies or errors, it can take actions as specified in the policy manifest, which may include sending notifications (e.g., traps), reverting the firmware to the previous stable version, or providing recommendations based on the analysis to address the identified problems.

If no issues are detected during the observation period, the deployment proceeds to scale out to a larger set of nodes, following the scaling policy defined in the policy manifest. This scaling can be performed in stages—for example, increasing from 10 nodes to 50 nodes, and then to 100 nodes-while observing the system's health after each stage. The scaling approach can be randomized or based on specific criteria to distribute the risk across different clusters.

In the event that errors are detected on some nodes, the services can take various actions based on the defined policy. These actions may include reverting the firmware to the previous version, a capability enabled by the BMC's firmware management functions. Additionally, the firmware deployment system 250 analyzes the logs to determine whether the issue is specific to the firmware or a more general hardware problem, providing valuable insights to system administrators.

The method accommodates the diverse nature of data center environments by allowing administrators to customize the deployment strategy according to their specific requirements and risk profiles. For instance, smaller data centers with fewer servers may opt for different scaling increments compared to large cloud service providers with hundreds of thousands of servers.

By integrating the monitoring capabilities of the BMCs and the centralized analysis provided by the firmware deployment system 250, this method enables a proactive approach to firmware management. It balances the need for timely updates, such as critical security patches, with the operational necessity of maintaining system stability and minimizing downtime.

In an embodiment, the firmware deployment system 250 comprises several key components, as illustrated in FIG. 2. These components include a discovery service 254, a cluster service 256, a policy and action manager 258, and a deployment manager 260. Each of these services may be implemented on a computing device having a structure similar to that of the host computer 180. These components interact with the BMCs (e.g., the BMC 222-1 to BMC 222-M) and the servers (e.g., the servers 232-1 to 232-N) within the data center 208 to facilitate a controlled and scalable firmware deployment process.

The discovery service 254 is responsible for identifying and cataloging the various nodes within the data center 208. It communicates with the BMCs (e.g., the BMCs 222-1 to 222-M) to gather information about the servers, such as hardware configurations, firmware versions, and operational statuses. This information is stored and utilized to create clusters based on selectable parameters, such as workload types, CPU models, GPU types, operating systems, or firmware generations. By understanding what different nodes are present and how the racks are configured, the discovery service 254 enables the creation of clusters that simplify the management of firmware deployment policies.

The cluster service 256 utilizes the information collected by the discovery service 254 to organize the servers into logical clusters. Administrators can create selective filters to group servers with similar characteristics, such as all servers running Intel platforms or those equipped with specific GPUs. This clustering makes it easier to manage deployment policies by allowing firmware updates to be targeted to specific groups of servers. Clusters can also be created based on operating systems, enabling filters at different levels to accommodate various deployment strategies.

The policy and action manager 258 interprets the policy manifest defined by the administrators. This policy manifest, which may be in formats such as YAML or JSON, specifies the parameters controlling the firmware update process. It includes details such as which nodes or clusters to update, the sequence of deployment, scaling policies, error management strategies, and actions to be taken in response to specific events. The policy and action manager 258 understands these policies and orchestrates the deployment accordingly, ensuring that firmware updates adhere to the administrator's specifications.

The deployment manager 260 orchestrates the actual deployment of firmware to the selected nodes or clusters. It communicates with the BMCs (e.g., the BMC 222-1 to BMC 222-M) to initiate firmware updates in an out-of-band manner, utilizing interfaces such as the network interface card 119. The firmware can be any type of firmware, including GPU firmware, CPLD firmware, FPGA firmware, or firmware for other hardware components. The deployment manager 260 thus provides a unified method for distributing updates across diverse hardware components within the data center.

Initially, the firmware is deployed to a small subset of the servers 232-1 to 232-N, as specified in the policy manifest. After deploying the firmware, the deployment manager 260 collaborates with the BMCs to monitor the health and stability of the updated systems. The deployment orchestration service handles this monitoring, aggregating data collected by the BMCs. The BMCs, equipped with enhanced observability features, collect raw data such as system logs, hardware health metrics, and operating system logs. This raw data provides detailed insights into system performance and is crucial for detecting any issues or anomalies that may arise from the firmware updates.

If no issues are detected during the observation period, the deployment scales out to a larger set of nodes, following the scaling policy defined in the manifest. This scaling can be performed in stages, for example, increasing from 10 nodes to 50 nodes, and then to 100 nodes, while observing the system's health after each stage. The scaling approach can be randomized or based on specific criteria to distribute the risk across different clusters.

If any issues are detected based on the collected logs and predefined error markers, the action manager 258 takes appropriate actions as specified in the policy manifest. These actions may include sending notifications (e.g., traps), rolling back the firmware to a previous version, or pausing further deployments. The BMCs receive the raw data, which allows for precise identification of problems, whether they originate from the firmware itself or from generic hardware issues. By adding observability into the BMC firmware, the system enhances its ability to monitor and respond to changes in system performance.

Through this structured approach involving the discovery service 254, cluster service 256, policy and action manager 258, and deployment manager 260, the system provides a scalable and flexible method for firmware deployment in complex data center environments. By allowing administrators to carefully control the deployment process and respond swiftly to any issues, this method reduces the risks associated with firmware updates. The integration of the BMCs in this process ensures that the system can collect comprehensive data and maintain system stability throughout the deployment.

A server policy management mechanism (e.g., the policy and action manager 258) is responsible for orchestrating the discovery, clustering, and policy-based control of firmware updates across the data center. This mechanism is facilitated by the firmware deployment system 250.

The firmware deployment system 250 initiates by discovering different nodes within the data center 208. This discovery process is managed by the discovery service 254, which interacts with the BMCs 222-1 to 222-M associated with the servers 232-1 to 232-N. The discovery service 254 collects comprehensive information about each node, including hardware configurations, workload types, CPU models, GPU specifications, server generations, and current firmware versions. This information is for understanding the heterogeneous environment of the data center.

Once the nodes are discovered, the cluster service 256 organizes the systems into logical clusters based on selectable parameters. Administrators can define clustering criteria such as workload type, CPU architecture, GPU model, generation of hardware, or specific firmware versions. For example, servers running similar workloads or sharing the same CPU type can be grouped together into clusters. This clustering process simplifies the management of firmware updates by allowing policies to be applied to specific groups of servers that share common characteristics.

After clustering, administrators can plan their firmware deployment operations by creating a policy manifest. The policy manifest is a document that contains detailed parameters controlling the firmware update process. It specifies which nodes or clusters are targeted for updates, the sequence and scaling of deployments, error management strategies, and actions to be taken in response to specific events or conditions. The policy manifest is typically represented in a structured format such as YAML or JSON, which allows for easy definition and parsing of the various parameters.

An example of a policy manifest in YAML format is shown below:
policy_manifest:
   name: ComputeCluster
   description: A compute cluster with multiple nodes
   Cluster_id: CL-1
   nodes:
      -node_id: node1
      ip_address: 192.168.1.101
      cpu:
         type: Intel Xeon Gold 6248
         cores: 20
         frequency: 2.5 GHz
      gpu:
         type: NVIDIA Tesla V100
         memory: 32 GB
         cuda_cores: 5120
      firmware_versions:
         BMC_Version: 2.2
         BIOS_Version: 1.5
         GPU_Version: 2.3
      -node_id: node3
      ip_address: 192.168.1.103
      cpu:
         type: Intel Xeon Platinum 8268
         cores: 24
         frequency: 2.9 GHz
      gpu:
         type: NVIDIA Tesla T4
         memory: 16 GB
         cuda_cores: 2560
      firmware_versions:
         BMC_Version: 2.2
         BIOS_Version: 1.5
         GPU_Version: 2.3
   Update_Nodes: [node1, node3]
   Trigger_Policy:
      Firmware_Update_Trigger: New VersionAvailable
      FirmwareScalePolicy: Random
   ErrorManagement:
      ErrorTriggers: [SEL, SystemLog, BMCProcessLog]
   ErrorActions:
      Communication: Traps
      RevertFirmware: False

In this policy manifest, administrators have specified a cluster named “ComputeCluster” with the identifier “CL-1”, consisting of specific nodes (node 1 and node3). The manifest includes detailed information about the nodes'hardware configurations and current firmware versions. The “Update_Nodes” field specifies the nodes to receive the firmware update.

The “Trigger_Policy” section defines the conditions under which the firmware update should be initiated. In this case, the update is triggered when a new firmware version becomes available, and the firmware scaling policy is set to “Random”, allowing the deployment manager 260 to select nodes randomly within the specified group for the initial update.

The “ErrorManagement” and “ErrorActions” sections outline how the system should respond to errors during the firmware update process. The system monitors specific error triggers, such as System Event Logs (SEL), system logs, and BMC process logs. If any of these errors are detected, the action specified is to send communication traps (notifications) without reverting the firmware, as indicated by “RevertFirmware: False”.

Administrators have the flexibility to choose whether to update individual nodes, entire clusters, or the complete data center manually or automatically, as defined in the policy manifest. This level of control allows for tailored deployment strategies that align with the operational requirements and risk tolerance of the data center.

The policy manifest is parsed and interpreted by the policy and action manager 258, which orchestrates the firmware deployment process according to the defined parameters. By utilizing a structured policy document, the system ensures that firmware updates are applied consistently and efficiently across the specified nodes or clusters.

The server policy management mechanism within the firmware deployment system 250 provides a comprehensive and flexible approach to firmware updates. By discovering nodes, creating clusters based on selectable parameters, and utilizing a detailed policy manifest, administrators can effectively plan and control the firmware update process, minimizing risks and maintaining system stability.

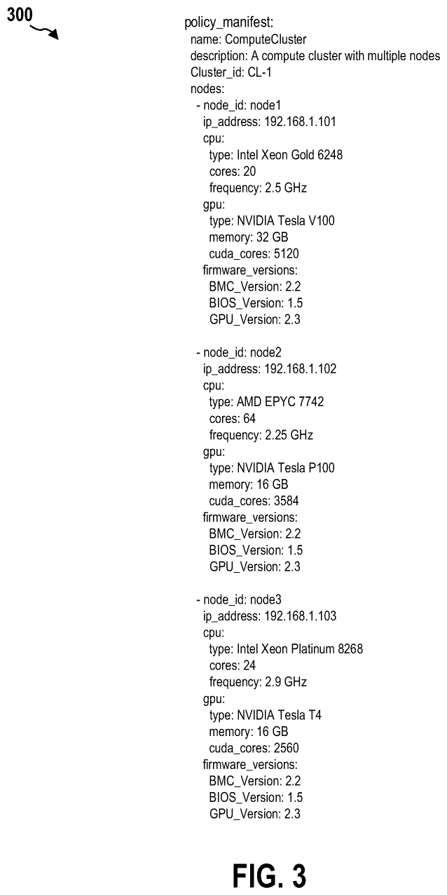

FIG. 3 shows a YAML file 300 specifies a policy manifest for a compute cluster, outlining the nodes to be updated, their configurations, and the policies governing the deployment. The policy manifest defines the parameters controlling the update procedure.

The policy manifest is structured to provide a comprehensive description of the compute cluster, identified by the name ComputeCluster and cluster ID CL-1. It lists the nodes within the cluster and specifies their hardware configurations and current firmware versions. This information is used for the policy and action manager 258 to orchestrate the firmware deployment accurately.
policy_manifest:
name: ComputeCluster
description: A compute cluster with multiple nodes
Cluster_id: CL-1
nodes:
. . .

The nodes section enumerates each node within the cluster, providing detailed hardware and firmware information. This data allows the deployment manager 260 to target specific nodes based on their configurations.

In this example, Node 1 is identified by nodel with an IP address of 192.168.1.101. Its hardware configuration includes an Intel Xeon Gold 6248 CPU and an NVIDIA Tesla V100 GPU.
-node_id: node 1
ip_address: 192.168.1.101
cpu:
   type: Intel Xeon Gold 6248
   cores: 20
   frequency: 2.5 GHz
gpu:
   type: NVIDIA Tesla V100
   memory: 32 GB
   cuda_cores: 5120
firmware_versions:
   BMC_Version: 2.2
   BIOS_Version: 1.5
   GPU_Version: 2.3

The CPU section specifies:
type: the CPU model, Intel Xeon Gold 6248;
cores: number of cores, 20; and
frequency: Operating frequency, 2.5 GHz.

The GPU section specifies:
type: the GPU model, NVIDIA Tesla V100;
memory: GPU memory, 32 GB; and
cuda_cores: Number of CUDA cores, 5120.

The firmware versions installed on Node 1 are:
BMC_Version: 2.2
BIOS_Version: 1.5
GPU_Version: 2.3

Similarly, configurations of Node 2 and Node 3 are specified. This information is used by the firmware deployment system 250 to manage firmware updates appropriately.

By specifying the hardware details and firmware versions of each node, the policy manifest allows the deployment manager 260 and the BMCs (e.g., the BMC 222-1 to BMC 222-M) to identify compatibility requirements for firmware updates; group nodes with similar configurations for efficient deployment; and avoid deploying incompatible firmware versions that could cause system instability.

While the YAML file shown in FIG. 3 focuses on the node configurations, it can be extended to include policy parameters that govern the firmware deployment process. These parameters define when and how updates are applied, error management strategies, and actions in response to detected issues.

The Update_Nodes field specifies which nodes are targeted for the firmware update and, in the below example, the nodes are node1 and node3:
Update_Nodes: [node1, node3].

This selection allows administrators to control the scope of the update, perhaps starting with a subset of nodes to monitor for issues before scaling the deployment.

The Trigger_Policy section defines the conditions under which firmware updates are initiated. In this example:
Trigger_Policy:
   Firmware_Update_Trigger: New VersionAvailable
   FirmwareScalePolicy: Random

“Firmware_Update_Trigger” specifies that updates are triggered when a new firmware version becomes available. “FirmwareScalePolicy” defines the scaling strategy, which in this case is Random, indicating that nodes are selected randomly for each deployment phase to distribute risk.

The “ErrorManagement” and “ErrorActions” sections outline how the system handles errors during the update process. In this example:
ErrorManagement:
   ErrorTriggers: [SEL, SystemLog, BMCProcessLog]
ErrorActions:
   Communication: Traps
   RevertFirmware: False

“ErrorTriggers” specifies the logs and indicators that the system monitors for errors:
SEL: System Event Log entries;
SystemLog: General system logs; and
BMCProcessLog: Logs from processes on the BMC.

“Communication” defines the method for alerting administrators to errors, in this case, using Traps, which are notifications sent through network management protocols.

“RevertFirmware” indicates whether the system should revert to the previous firmware version upon detecting errors. A value of False means the system will not automatically revert, allowing administrators to analyze the issue before deciding on a course of action.

The detailed policy manifest interacts with various components of the system. The BMC 222-1 to BMC 222-M utilizes the firmware versions and error triggers to manage updates and monitor system health. The deployment manager 260 executes the firmware deployment according to the defined policies, communicates with BMCs, and scales the deployment based on observed outcomes. The policy and action manager 258 interprets the policy manifest and coordinates actions in response to events during the deployment process. The servers 232-1 to 232-N are the physical nodes that receive firmware updates and report status information back to the firmware deployment system 250.

The file format allows administrators to customize the policy manifest to suit the specific needs of their data center environment. Parameters can be adjusted to:
target different clusters or nodes based on hardware configurations;
change scaling policies to control the pace of deployment; and
modify error management strategies to either automatically revert firmware or allow for manual intervention.

This flexibility is particularly important in heterogeneous environments, where nodes may have varying requirements and risk profiles. The policy manifest enables the discovery service 254 to understand which nodes to monitor and manage. The cluster service 256 uses the node information to organize systems into logical groups for efficient deployment. The policy and action manager 258 ensures that deployments adhere to the specified policies, enhancing reliability. By providing a structured and detailed description of the deployment parameters, the policy manifest facilitates a controlled and scalable firmware update process, minimizing the risk of downtime and maintaining system health.

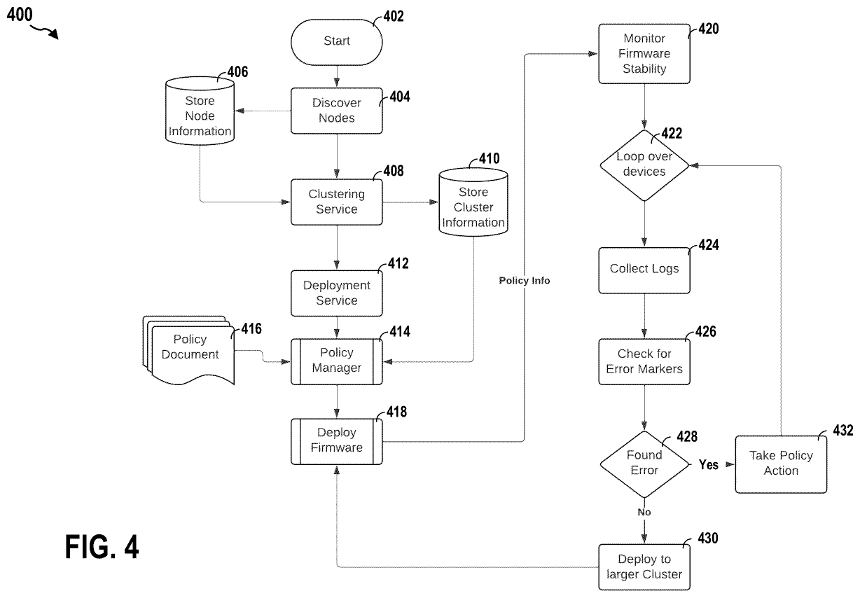

FIG. 4 is a flowchart of process for scaled firmware deployment based on observable health markers. The process may be performed by the firmware deployment system 250. In operation 402, the process is initiated. In operation 404, the system performs node discovery within the data center. This involves identifying all servers or nodes connected to the network. The discovery process gathers information about each node, including hardware configurations, firmware versions, IP addresses, and workload types.

Following the discovery, operation 406 involves storing the collected node information. This stored data serves as a comprehensive inventory of the nodes, which is used for subsequent clustering and deployment steps.

In operation 408, a clustering service organizes the nodes into clusters based on selectable parameters defined by the administrator. These parameters may include workload types, CPU types, GPU types, hardware generations, and firmware versions. By grouping nodes with similar characteristics, the system facilitates targeted firmware deployment and management.

In operation 410, the system stores the cluster information obtained from the clustering service. This includes details about each cluster and the nodes within them, enabling efficient tracking and management during the deployment process.

In operation 412, a deployment manager prepares for firmware deployment by referencing a policy document specified in operation 416. The policy document contains parameters that control the firmware update process, such as the selection of nodes or clusters to update, update frequencies, version thresholds, and triggers for updates (e.g., availability of new firmware versions or security fixes).

The policy manager, in operation 414, interprets the policy document and orchestrates the deployment process accordingly. The deployment manager then proceeds to operation 418, where it deploys the firmware to the selected nodes or clusters as dictated by the policy.

After the firmware has been deployed, the system enters operation 420 to monitor firmware stability on the updated nodes. This system continuously observes the performance and health of the nodes over a specified duration to detect any issues arising from the firmware update.

Operation 422 represents a loop over the devices that have received the firmware update. For each device, the system performs operations 424 and 426.

In operation 424, the system collects logs and telemetry data from each device. This data may include system event logs (SEL), system logs, baseboard management controller (BMC) process logs, health information, and event data. These logs provide insights into the operational status of the nodes following the firmware update.

In operation 426, the system analyzes the collected logs to check for error markers. The system examines the logs for any anomalies or indications of issues such as hardware malfunctions, firmware incompatibilities, or performance degradations.

At decision point 428, the system determines whether any errors have been found. If errors are detected, the process proceeds to operation 432, where the system takes policy-defined actions. These actions may include reverting the firmware to a previous stable version, sending notifications or alerts (e.g., traps), or providing recommendations based on the error analysis.

If no errors are found, the system advances to operation 430 to deploy the firmware to a larger cluster of nodes. The scaling of deployment follows the guidelines specified in the policy document, potentially increasing the number of nodes in each subsequent deployment phase (e.g., scaling from 10 nodes to 50 nodes, and then to 100 nodes).

The process then loops back to operation 418, where the firmware is deployed to the next set of nodes based on the updated scale. The monitoring cycle repeats with each deployment phase. Issues can be promptly identified and addressed according to the policy.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of operating a computer system for scaled firmware deployment based on observable health markers, the method comprising:
a) discovering a plurality of nodes within a data center;
b) clustering the plurality of nodes into groups based on selectable parameters;
c) deploying firmware to selected nodes or clusters based on a policy manifest;
d) monitoring firmware stability on the selected nodes by collecting device data from each selected node;
e) analyzing the collected device data to detect one or more errors; and
f) when no errors are detected, deploying the firmware to a larger cluster of nodes according to the policy manifest.

2. The method of claim 1, further comprising: when errors are detected, performing one or more actions as specified in the policy manifest.

3. The method of claim 2, wherein the actions specified in the policy manifest upon detecting one or more errors include one or more of:
a) sending notifications to administrators;
b) reverting the firmware on the selected nodes to a previous version; and
c) providing recommendations based on analysis of the errors.

4. The method of claim 1, wherein the selectable parameters for clustering the nodes include one or more of: workload type, CPU type, GPU type, hardware generation, and current firmware version.

5. The method of claim 1, wherein the policy manifest is represented in a structured format including YAML or JSON and specifies parameters controlling the firmware update process.

6. The method of claim 1, wherein deploying the firmware to selected nodes comprises deploying the firmware to a subset of nodes selected randomly according to the policy manifest.

7. The method of claim 1, wherein monitoring firmware stability comprises observing the selected nodes over a specified observation period defined in the policy manifest.

8. The method of claim 1, wherein analyzing the collected device data comprises checking for predefined error markers including system event logs, system logs, and baseboard management controller (BMC) process logs.

9. The method of claim 1, wherein the firmware includes telemetry and analytics packages that collect information including logs, health information, and events, and send it to a management service.

10. The method of claim 1, wherein deploying the firmware is performed through a baseboard management controller (BMC) in communication with each selected node.

11. The method of claim 1, further comprising using a discovery service to identify the plurality of nodes within the data center.

12. The method of claim 1, further comprising using a cluster service to organize the nodes into clusters based on the selectable parameters.

13. The method of claim 1, further comprising using a deployment manager to deploy the firmware to the selected nodes or clusters and to the larger cluster of nodes as defined in the policy manifest.

14. The method of claim 1, wherein the policy manifest specifies trigger policies, scaling policies, error management strategies, and error actions for the firmware deployment.

15. The method of claim 1, wherein the larger cluster of nodes comprises an increased number of nodes as defined in the scaling policies of the policy manifest.

16. The method of claim 1, further comprising repeating steps d) through f) iteratively to deploy the firmware to progressively larger clusters until the firmware is deployed to all targeted nodes in the data center as specified by the policy manifest.

17. A computer system, comprising:
a memory; and
at least one processor coupled to the memory and configured to:
a) discover a plurality of nodes within a data center;
b) cluster the plurality of nodes into groups based on selectable parameters;
c) deploy firmware to selected nodes or clusters based on a policy manifest;
d) monitor firmware stability on the selected nodes by collecting device data from each selected node;
e) analyze the collected device data to detect one or more errors; and
f) when no errors are detected, deploy the firmware to a larger cluster of nodes according to the policy manifest.

18. The computer system of claim 17, wherein the at least one processor is further configured to:
when errors are detected, perform one or more actions as specified in the policy manifest.

19. The computer system of claim 18, wherein the actions specified in the policy manifest upon detecting one or more errors include one or more of:
a) sending notifications to administrators;
b) reverting the firmware on the selected nodes to a previous version; and
c) providing recommendations based on analysis of the errors.

20. A non-transitory computer-readable medium storing computer executable code for operation of a computer system, comprising code to:
a) discover a plurality of nodes within a data center;
b) cluster the plurality of nodes into groups based on selectable parameters;
c) deploy firmware to selected nodes or clusters based on a policy manifest;
d) monitor firmware stability on the selected nodes by collecting device data from each selected node;
e) analyze the collected device data to detect one or more errors; and
f) when no errors are detected, deploy the firmware to a larger cluster of nodes according to the policy manifest.
